(19) United States
(12) Patent Application Publication
(10) Pub. No.: US 2019/0327789 A1
(43) Pub. Date: Oct. 24, 2019

(54) CELLULAR EXTENSION ON A DATALINK LAYER COMMUNICATION CHANNEL

(71) Applicant: Microsoft Technology Licensing, LLC, Redmond, WA (US)

(72) Inventors: Dejun ZHANG, Bellevue, WA (US); Ying N. CHIN, Bellevue, WA (US); Robert ZHU, Bellevue, WA (US); Lei ZHANG, Redmond, WA (US); Bin WANG, Bellevue, WA (US); Shu PENG, Redmond, WA (US); Daryl Alan WELSH, Bellevue, WA (US)

(21) Appl. No.: 15/958,151

(22) Filed: Apr. 20, 2018

(51) Int. Cl. H04W 92/04; H04W 4/14; H04W 76/14; H04W 88/06

(52) U.S. Cl. CPC H04W 92/04; H04W 88/06; H04W 76/14; H04W 4/14

(57) ABSTRACT

Cellular network communication functionality of a device is extended to another device that may or may not include cellular communications functionality. The cellular network communications functionality is extended over a datalink layer communication channel that is established between the devices. A cellular data channel is established over the datalink layer communication channel via a cellular interface translator of a server device and a cellular interface translator of a client device. Communication data is transmitted between the cellular communication hardware system of the server device and the cellular interface translator of the client device via the cellular data channel generated over the datalink layer communication channel.

### BACKGROUND

Some computing devices, such as smart phones, are implemented with cellular communication circuitry for communicating cellular voice and SMS data over a cellular communication network. Other computing devices are not implemented with cellular functionality and may utilize data networks, such as the internet, for communication. For example, non-cellular devices may utilize voice over internet protocol (voice over IP) for communication.

### SUMMARY

Implementations described and claimed herein include a method, process, and system for extending a datalink layer from local device to a remote device. An example method includes establishing a datalink layer communication channel between the local device and the remote device. The datalink layer communication channel is established responsive to a request initiated at one of the local device and the remote device. The method further includes communicating between the local device and the remote device via the established datalink layer communication channel to process a request for generating a cellular data channel over the established datalink layer communication channel and generating the cellular data channel over the established datalink layer communication channel via a local cellular interface translator of the local device and a remote cellular interface translator of the remote device. The local cellular interface translator is configured to communicate with a cellular communication hardware system of the local device via a cellular interface of the local device. The method further includes transmitting communication data between the cellular communication hardware system of the local device and the remote cellular interface translator of the remote device via the cellular data channel generated over the datalink layer communication channel.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example environment for cellular extension on a datalink layer communication channel.

FIG. 2 illustrates another example environment for cellular extension on a datalink layer communication channel.

FIG. 3 illustrates a block diagram of an example system for cellular extension on a datalink layer communication channel.

FIG. 4 illustrates a diagram of example data sources and flows for cellular extension on a datalink layer communication channel.

FIG. 5 illustrates another diagram of an example data sources and flows for cellular extension on a datalink layer communication channel.

FIG. 6 illustrates example operations for cellular extension on a datalink layer communication channel.

FIG. 7 illustrates example operations for cellular extension on a datalink layer communication channel.

FIG. 8 an example system that may be useful in implementing the described technology.

### DETAILED DESCRIPTIONS

Cellular network communication functionality of a device is extended to another device that may or may not include cellular communications functionality. The cellular network communications functionality is extended over a datalink layer communication channel that is established between the devices. Extending the cellular functionality from the cellular device (referred to herein as a “server device”) to the other device (referred to herein as a “client device”) permits the client device to utilize the cellular communications hardware system of the server device for cellular communication (e.g., cellular voice and SMS) and for resource data.

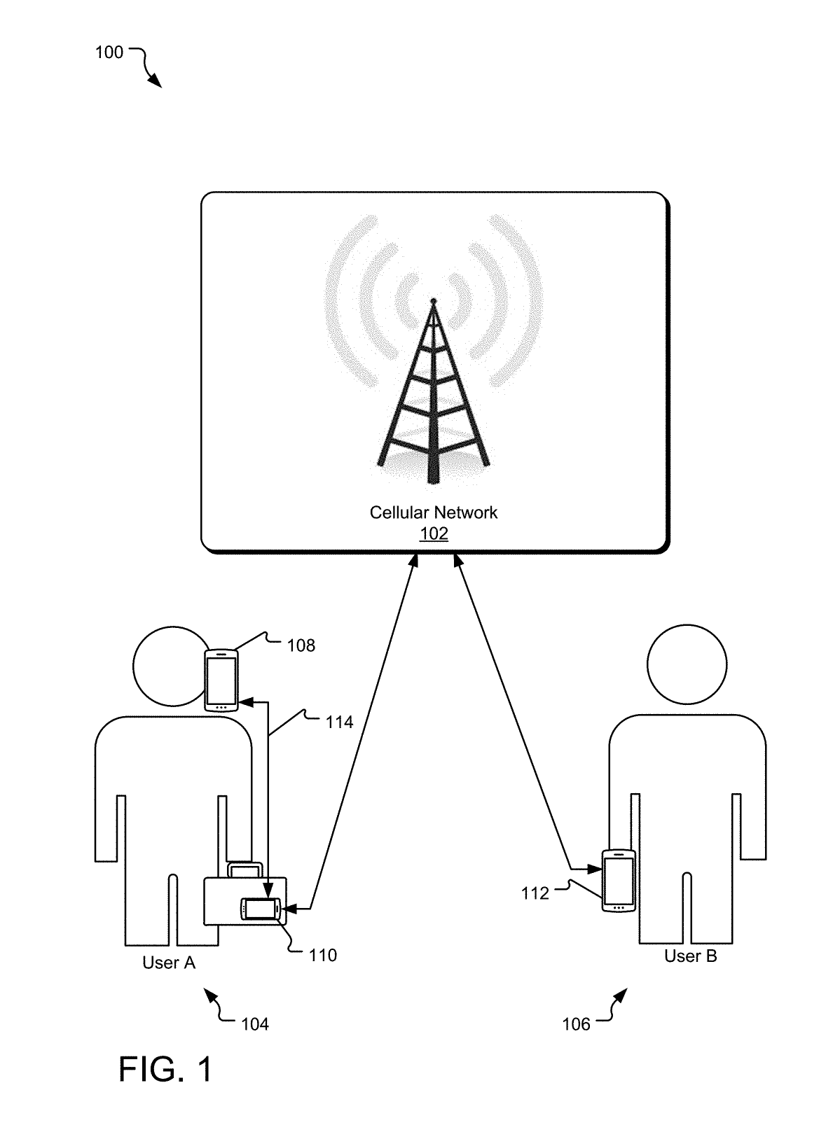

FIG. 1 illustrates an example environment 100 for cellular extension on a datalink layer communication channel 114. The environment 100 includes a user A 104, a user B 106, and a cellular network 102. The cellular network 102 includes one or more components for facilitating communications via a cellular network protocol, such as and without limitation 3G, 4G, LTE. The user A 104 and the user B 106 carry mobile devices (e.g., mobile devices 108, 110, and 112) that may include communication circuitry for communication over the cellular network 102 and one or more local area networks (e.g., a Wi-Fi network, BlueTooth, radio communication network, near field communication (NFC)).

In the example illustrated implementation, the user A 104 carries two mobile devices 108 and 110. The mobile device 110, which is illustrated as being stored in a briefcase of the user A 104, includes cellular communication circuitry (e.g., a cellular antenna, a subscriber identification module (SIM) card, a modem) for communication over the cellular network 102. The mobile device 108 may or may not include cellular communication circuitry for communication over the cellular network 102. However, the mobile device 108 at least includes communication circuitry for communicating over a local network such as Wi-Fi, BlueTooth, etc.

Instead of utilizing cellular communication circuitry within the mobile device 108 for communicating with the user B 106, the user A 104 extends the cellular communication circuitry of the mobile device 110 into the mobile device 108 to communicate over the cellular network 102 and with the mobile device 112 of the user B 106. As described in detail below, the datalink layer communication channel 114 is established between the mobile device 108 and 110. Thus, the user A 108 may place and receive cellular calls (e.g., transmit and receive cellular data) and transmit and receive SMS data (e.g., SMS messages) via the mobile device 108 but via the cellular communication circuitry of the mobile device 110. Such a process is referred to herein as a cellular extension on a datalink layer communication channel. This process may be useful in a number of difference scenarios. In one example scenario, the mobile device 110 is a work device of the user A 104, and the user A 104 calls a client (e.g., the user B 106) via the mobile device 108 (e.g., a personal device) but using the cellular information/circuitry implemented in the mobile device 110. Thus, the mobile device 112 of the user B 106 may display the caller identification information of the mobile device 110 instead of the mobile device 108. In another example scenario, instead of the mobile device 108 being a mobile device, the mobile device 108 is a tablet, desktop, or laptop computer, for example, and utilizes the cellular communication circuitry of the mobile device 110 to place/receive cellular calls and SMS messages.

To implement cellular extension on a datalink layer communication channel, the mobile devices 108 and 110 are “paired” over datalink layer communication channel 114, such as BlueTooth, Wi-Fi, NFC, etc. The pairing process may include authorizing one or more devices, entering network identifying information on a device, trading cryptographic keys, trading credentials, etc. After the devices are paired, the mobile devices 108 and 110 generate a cellular data channel over the established datalink layer communication channel 114. Generation of a cellular data channel may include installation of cellular interface translators at the mobile devices 108 and 110. The cellular interface translators are applications, application code segments, or modules, etc. embodied in processor executable instructions stored in one or more storage media of the devices. The cellular interface translators are configured to simulate the communication processes of a cellular interface that is installed on the devices. An example cellular interface is a radio interface layer (RIL) that is a communication interface between applications (e.g., phone applications, SMS applications) and the cellular communication circuitry system of the device (e.g., modem, SIM card, transceiver, antenna). Thus, the mobile device 110 may include a cellular interface as an RIL that is configured to communicate between the cellular communication circuitry system and the phone application of the mobile device 110. The cellular interface translator of the mobile device 110 is configured to communicate with the RIL (e.g., the cellular interface) to cause the cellular communication circuitry system to perform cellular communication with the cellular network 102.

In the illustrated implementation, the mobile device 110 may be referred to as a “server” device, and the mobile device 108 may be referred to as a “client” device because the mobile device 110 serves the cellular data to the mobile device 108 (e.g., a client/server model). The cellular interface translator of the mobile device 108 transmits cellular data to the cellular interface translator of the mobile device 110 and receives cellular data from the cellular interface translator of the mobile device 110. Thus, cellular communication data received from the cellular network 102 at the communication circuitry system of the mobile device 110 may be transmitted over the datalink layer communication channel 114 to the mobile device 108 and presented to the user via an application (e.g., a phone or SMS application). When the mobile devices 108 and 110 are communicatively connected via the datalink layer communication channel 114, the mobile devices are “paired” for the purposes of the implementations described herein. Thus, the user A 104 may place a cellular call via the mobile device 108, receive a cellular call via the mobile device 108, transmit or receive SMS messages without needing to reconfigure or directly operate the mobile device 110. Furthermore, because the cellular communication channel is generated over the datalink layer communication channel 114, the mobile devices 110 and 110 may receive calls or SMS message almost simultaneously.

The implementations described herein may be further utilized to transmit cellular hardware system information (e.g., SIM card information) from the mobile device 110 to the mobile device 110. Such information may also be referred to as communication data and is utilized by the mobile device 108 for varying purposes. For example, if the user 104 installs a new application on the mobile device 108 that was previously installed on the mobile device 110, the application may require multiple layers of authentication. A first layer of authentication may require a username and password that is entered by the user A 104. Another layer of authentication is SIM card information or other subscriber or device identifying information. In some example scenarios, the mobile device 108 may not have such information (e.g., not linked to a cellular network) or the mobile device 108 may not be configurable with such information (e.g., a laptop, tablet, desktop). Thus, the mobile device 108 may request and receive the device or user identifying information from the mobile device 110 over the datalink layer communication channel 114. The received identifying information may be utilized to authenticate the mobile device 108 using the information that is retrieved from the mobile device 110.

The implementations described herein allow for a cellular capable device (e.g., the mobile device 110) to be utilized by another device (either cellular capable or not) to utilize the cellular capable device as a cellular extension for cellular communication (e.g., voice and SMS cellular data). Because the extension is implemented via the datalink layer communication channel 114 that is configured on one or both of the devices, the extension is secure. In other words, to “pair” the devices, the devices share encryption keys and credentials (e.g., via a handshake process) such that any communication via the datalink layer communication channel 114 is secure.

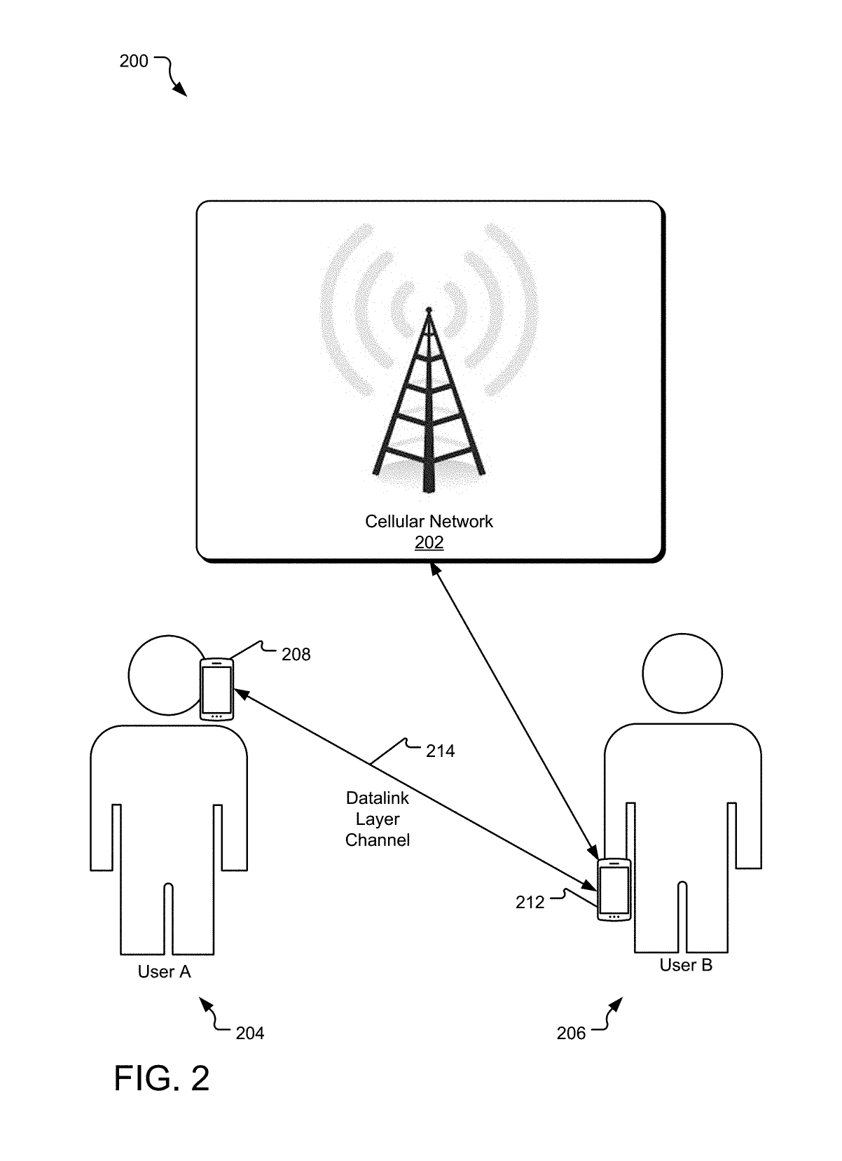

FIG. 2 illustrates another example environment 200 for cellular extension on a datalink layer communication channel. The environment 200 includes a user A 204, a user B 206, and a cellular network 202. The cellular network 202 includes one or more components for facilitating communications via a cellular network protocol, such as and without limitation 3G, 4G, LTE. The user A 204 and the user B 206 carry mobile devices (e.g., mobile devices 208 and 212) that may include communication circuitry for communication over the cellular network 202 and one or more local area networks (e.g., a Wi-Fi network, BlueTooth, radio communication network, near field communication (NFC)).

In the illustrated implementation, the user A 204 carries the mobile device 208, and the user B carries the mobile device 212 which includes the communication circuitry (e.g., a cellular antenna, a subscriber identification module (SIM) card) for communication over the cellular network 202. The mobile device 208 may or may not include communication circuitry for communication over the cellular network 202. However, the mobile device 208 at least includes communication circuitry for communicating over a local network such as Wi-Fi, BlueTooth, etc.

Instead of utilizing cellular communication circuitry within the mobile device 208 for communicating over the cellular network 202, the user A 204 extends the cellular communication circuitry of the mobile device 212 into the mobile device 208 to communicate over the cellular network 202. The datalink layer communication channel 214 is established between the mobile device 208 and 212. Thus, the user A 208 may place and receive cellular calls and call requests (e.g., transmit and receive cellular data) and transmit and receive SMS data (e.g., SMS messages) via the mobile device 208 but via the cellular communication circuitry of the mobile device 212. Such a process is referred to herein as a cellular extension on a datalink layer communication channel. In the example scenario illustrated in FIG. 2, the user B 206 may be a parent, and the user A may be a child. The child (e.g., the user A 204) has a device that is not able to connect directly to the cellular network 202 or the cellular circuitry of the mobile device 208 may be disabled. Thus, the user A 204 may connect to the mobile device 212 of the user B 206 to connect to the cellular network 202. This allows for the mobile device 212 to act as a “relay” for cellular communication (e.g., SMS and cellular voice data) for the mobile device 208. In another example scenario, instead of the mobile device 208 being a mobile device, the mobile device 208 is a tablet, desktop, or laptop computer, for example, and utilizes the cellular communication circuitry of the mobile device 212 to place/receive cellular calls and SMS messages.

To implement cellular extension on a datalink layer communication channel, the mobile devices 208 and 212 are “paired” over datalink layer communication channel 214 such as BlueTooth, Wi-Fi, NFC, etc. It should be understood that any type datalink layer communication channel that provides enough latency and/or bandwidth may be used for implementation of the descried technology. The pairing process may include authorizing one or more devices, entering network identifying information on a device, trading cryptographic keys, trading credentials, (e.g., a handshake), etc. After the devices are paired, the mobile devices 208 and 212 generate a cellular data channel over the established datalink layer communication channel 214. Generation of a cellular data channel may include installation of cellular interface translators at the mobile devices 208 and 212. The cellular interface translators are applications, application code segments, or modules, etc. embodied in processor executable instructions stored in one or more storage media of the devices. The cellular interface translators are configured to simulate the communication processes of a cellular interface that is installed on the devices. An example cellular interface is a radio interface layer (RIL) that is a communication interface between applications (e.g., phone applications, SMS applications) and the cellular communication circuitry system of the device (e.g., modem, SIM card, transceiver, antenna). Thus, the mobile device 212 may include a cellular interface as an RIL that is configured to communicate between the cellular communication circuitry system and the phone application of the mobile device 212. The cellular interface translator of the mobile device 212 is configured to communicate with the RIL (e.g., the cellular interface) to cause the cellular communication circuitry system to perform cellular communication with the cellular network 202.

In the illustrated implementation, the mobile device 212 may be referred to as a “server” device, and the mobile device 208 may be referred to as a “client” device because the mobile device 212 serves the cellular data to the mobile device 208 (e.g., a client/server model). The cellular interface translator of the mobile device 208 transmits cellular data to the cellular interface translator of the mobile device 210 and receives cellular data from the cellular interface translator of the mobile device 210. Thus, any cellular communication data received from the cellular network 202 at the communication circuitry system of the mobile device 212 may be transmitted over the datalink layer communication channel 214 to the mobile device 208 and presented to the user via an application (e.g., a phone or SMS application). When the mobile devices 208 and 212 are communicatively connected via the datalink layer communication channel 214, the mobile devices are “paired” for the purposes of the implementations described herein. Thus, the user A 204 may place a cellular call via the mobile device 208, receive a cellular call via the mobile device 208, transmit or receive SMS messages without having to reconfigure or utilize the mobile device 212. Furthermore, because the cellular communication channel is generated over the datalink layer communication channel 214, the mobile devices 212 and 212 may receive calls or SMS message almost simultaneously.

The mobile device 208 may also request and receive device and subscriber identifying information (e.g., cellular data) over the datalink layer communication channel 214. Thus, the mobile device 208 may utilize such information for purposes such as authenticating access to an installed application.

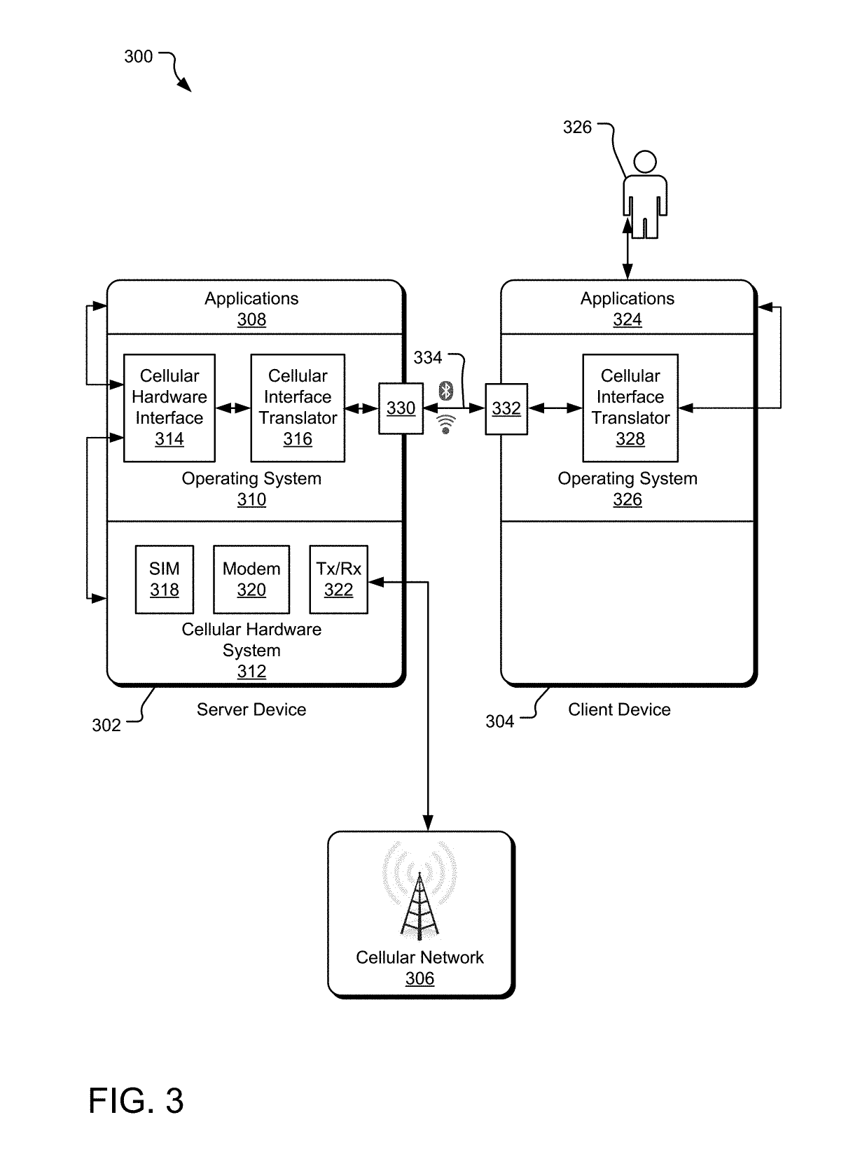

FIG. 3 illustrates an example block diagram 300 of an example system for cellular extension on a datalink layer communication channel. The block diagram 300 includes a server device 302, a client device 304 and a cellular network 306. The server device 302 may be any type of device configured for cellular data communication, such as and without limitation a smart phone and a tablet. The client device 304 may be any device configured for datalink layer communication (e.g., BlueTooth, Wi-Fi, NFC), such as and without limitation a smart phone, tablet, laptop computing device, desktop computing device. It should be understood that the terms “server device” and “client device” are not meant to limit the devices to a server system or client system.

The server device 302 includes one or more applications 308, and operating system 310, and a cellular hardware system 312. The applications 308 include client applications, such as and without limitation, a phone application, a SMS application, and other client applications.

The operating system 310 includes a cellular hardware interface 314 that functions as an abstraction layer between the applications 308 and the cellular hardware system 312. For example, a phone application of the applications 308 may communicate instructions to the cellular hardware interface 314 via an application programming interface (API) (not shown) for enabling cellular voice data functionality. An example instruction communicated by the phone application includes a call out instruction. The call out instruction may include data such as a recipient phone number. The operating system 310 further includes a cellular interface translator 316, which functions as an interface between a remote device (e.g., the client device 304) and the cellular hardware interface 314. The cellular hardware interface translator 316 may access datalink layer communication functionality such as BlueTooth or Wi-Fi ports and systems via a datalink layer interface 330. The cellular hardware interface translator 316 formats communication data to be transmitted via the datalink layer communication channel 334 and to the cellular interface translator 328 of the client device 304. The cellular interface translator 316 further receives data via the datalink layer communication channel 328 and formats the data for the cellular hardware interface 314. Such translation may include formatting the data as if the data was generated by a phone application (or other cellular data application) executing on the server device 302. The cellular interface translator 316 may communicate with the application programming interface (API) to access the cellular hardware interface 314 as if the cellular interface translator 316 were one of the applications 308.

The cellular hardware system 312 may include a subscriber identity module (SIM) 318 a modem 320, and a transceiver 322. The SIM 318 may be integrated into the server device 302 or may be removeably coupled to the server device 302 as a smart card. The SIM 318 may be an integrated circuit that securely stores device and cellular subscriber identification information. The subscriber identification information may also include a cryptographic key for secure communication (e.g., encryption). The SIM 318 may also store serial numbers, authentication and ciphering information, temporary network information, passwords, services information, a PIN, and other information.

The modem 320 is a network hardware and/or software device that encodes data into a carrier wave signal for transmission via a cellular antenna (not shown) of the server device 302. The modem 320 is also configured to decode data received via a carrier wave. The transceiver is communicatively coupled to one or more cellular antennas (not shown) and is configured to transmit and receive carrier wave signals in one or more radiofrequency (RF) bands. It should be understood that the cellular hardware system 312 may also include additional circuitry, hardware, and software for processing, transmitting, receiving, etc. RF signals.

The server device 302 and the client device 304 are “paired” over a datalink layer communication channel 334. The datalink layer communication channel 334 is established between the server device 302 and the client device 304 responsive to one of the server device 302 and the client device 304 requesting to pair or connect. To pair the devices, the devices may trade or establish cryptographic keys for secure communication (e.g., via a “handshake” process). After the devices are paired, the devices may be communicatively connected when the devices are within a communication proximity of one another (e.g., defined by the range of the communication protocol). After the server device 302 and the client device 304 are paired, the devices generate a cellular data channel over the datalink layer communication channel 334. In some implementations, the cellular data channel may be generated responsive to a request to generate the channel (e.g., based on a call placed or received or SMS message transmitted or received). Generating of the cellular data channel over the datalink layer communication channel 334 includes linking the cellular interface translator 316 of the server device 302 and a cellular interface translator 328 of the client device 304.

One or more applications 324 of the client device 304 interact with the cellular interface translator 328 of an operating system 326 of the client device 304. Example applications 324 that may interact with the cellular interface translator 328 include a phone application. In some example implementations, the client device 304 includes a cellular hardware system, and in other implementations, the client device 304 does not include cellular hardware system. Thus, the applications 324 communication with the cellular interface translator 328 as if the cellular interface translator 328 was configured to communicate directly with a cellular hardware system. Such communication may include requesting cellular network connectivity (e.g., placing calls or transmitting SMS messages) or receiving communication from the cellular network 306 (e.g., receiving calls or receiving SMS messages). The cellular interface translator 328 of the client device 304 receives communication data from the applications 324 via a datalink layer interface 332 (e.g., a BlueTooth interface), formats the data for communicating the data over the datalink layer communication channel 334, and communications the data to the cellular interface translator 316 of the server device 302 to extend the cellular functionality of the server device 302. The cellular interface translator 328 is further configured to receive formatted cellular data from the cellular interface translator 316 of the server device and translate the formatted data for the applications 324 (e.g., a phone application). The cellular interface translator 328 may utilize a datalink layer interface 330 (e.g., a BlueTooth interface) for extending the cellular functionality. The applications 324 present the cellular data to a user 326 (e.g., generate audio voice data or display SMS messages). Accordingly, the applications 324 communicate cellular data without using a SIM of a cellular hardware subsystem of the client device 304. In other words, the applications 324 may generate cellular data (e.g., generate audio data or display SMS data on a display) and receive/communicate cellular data without using a SIM of the client device 304.

The datalink layer interfaces 330 and 332 are utilized by the respective devices to establish the datalink layer communication channel 334 between the devices and to process requests for generating a cellular data channel over the established datalink layer communication channel 334 responsive to a request communicated between the devices. The datalink layer interfaces 330 and 332 function to “pair” the devices over the datalink layer communication channel 334. When the devices are paired, the cellular interface translator 318 essentially “registers” with the API for communicating with the cellular hardware interface 314 and may include registering identifying information for the client device 304 (e.g., identifying information for the cellular interface translator 328).

The cellular interface translator 316 may further format and transmit resource data (e.g., subscriber or mobile identifying information) over the cellular data channel to the cellular interface translator 328. For example, if one of the applications 324 requires identifying data for authenticating access to application data by the user 326, then the applications 324 requests such data from the cellular interface translator 328. The cellular interface translator 328 transmits a request to the cellular interface translator 316 over the cellular communication channel. The cellular interface translator 316 requests such data from the cellular hardware interface 314, which retrieves the requested information from the cellular hardware system 312 (e.g., the SIM 318). The information is then transmitted back to the cellular interface translator 328 and utilized by the applications 324 to authenticate the user 326.

In some example implementations, multiple client devices (e.g., the client device 304) may be paired with the server device 302. In an example scenario where this may be useful, the server device 302 is the cellular connected device of a household. Other household devices of the family (e.g., smart phones, tablets, desktops, laptops) are paired with the server device 302 over one or more datalink layer communication channels. Thus, the paired client devices may utilize the server device for cellular communications. When multiple devices are paired with the server device 302, the devices may utilize device identifying information or cellular interface translator identifying information of the client devices to determine which device to communicate with. Accordingly, multiple devices may be paired with (or registered with) the API of the server device 302.

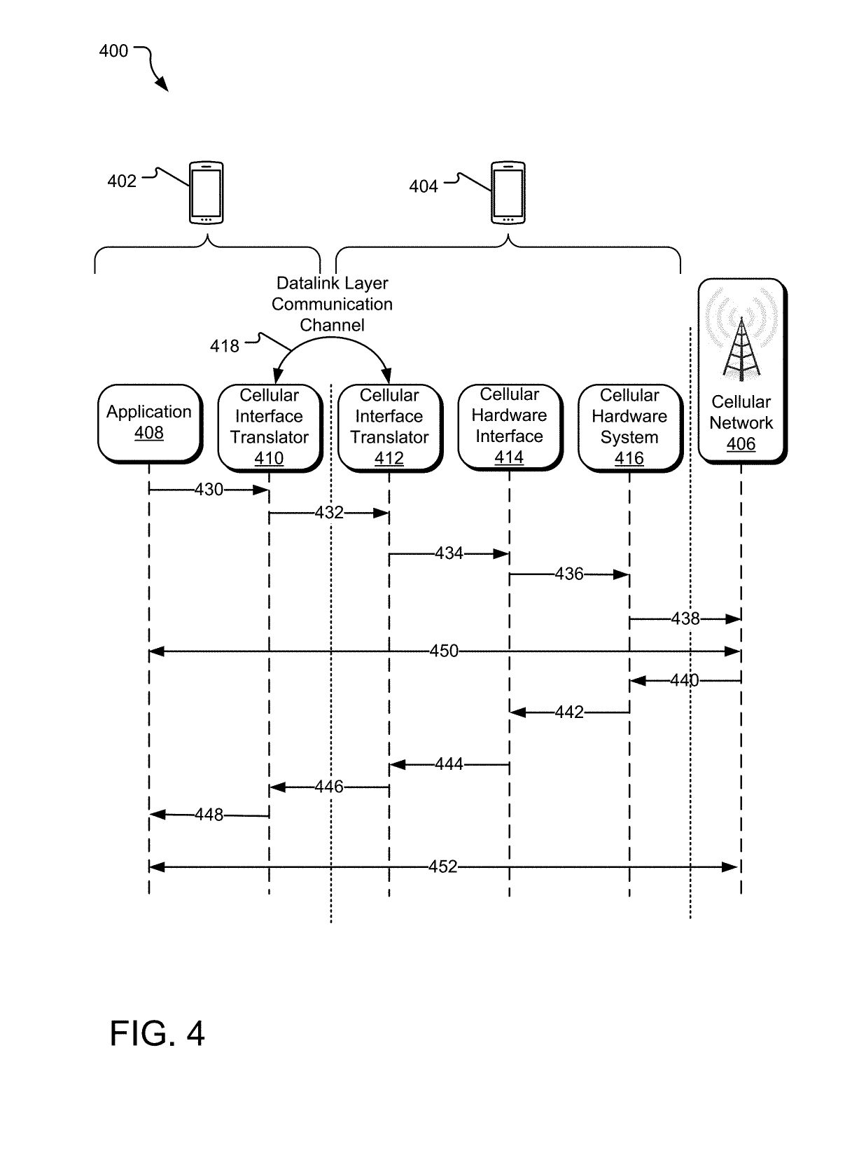

FIG. 4 illustrates an example diagram 400 of data sources and flows for cellular extension on a datalink layer communication channel. The diagram 400 includes a client device 402 a server device 404 and a cellular network 406. The client device 402 includes an application 408, and a cellular interface translator 412. The server device 404 includes a cellular interface translator 412, a cellular hardware interface 414 and a cellular hardware system 416. The client device 402 and the server device 404 have generated a cellular data channel over an established datalink layer communication channel 418. The datalink layer communication channel 418 may be established by a pairing process, such as BlueTooth pairing or Wi-Fi connection, for example. The cellular data channel is established by connecting the cellular interface translator 410 of the client device 402 and the cellular interface translator 412 of the server device 404.

FIG. 4 specifically illustrates cellular data extension on a datalink layer communication channel for communication over the cellular network 406. The application 408 on the client device 402 transmits a request 430 for a cellular data transmission (e.g., a cellular voice call or SMS message). The dataflow illustrated in FIG. 4 are described with respect to a cellular voice call, but it should be understood that similar dataflow is present when an SMS is transmitted or received. The request 430 is transmitted by the application 408 (e.g., a phone application) to the cellular interface translator 410. The request 430 may include call recipient identifying information (e.g., a phone number). The cellular interface translator 410 transmits the request 432 via the cellular data channel generated over the datalink layer communication channel 418 to the cellular interface translator 412. The cellular interface translator 412 may translate the request and transmit a request 434 to the cellular hardware interface 414, which is configured to communicate with the cellular hardware system 416. The cellular hardware interface 414 transmits a request 436 to the cellular hardware system 416. The cellular hardware system 416 transmits a request 438 to the cellular network 406, which transmits a communication to a recipient device (not shown), such as a mobile device or landline. If the call is accepted by the recipient, then a voice data channel 450 is established between the recipient and the application 408. The voice data is transmitted between the cellular network 406, various components of the client device 402, and the server device 404 across the cellular data channel generated over the datalink layer communication channel 418.

When a call is received via the cellular network 406, the cellular network 406 transmits a request 440 to the cellular hardware system 416 of the server device 404. The cellular hardware system 416 transmits the request 442 to the cellular hardware interface 414, which transmits the request 444 to the cellular interface translator 412. In some example implementations, the cellular hardware interface 414 transmits the request to a phone application on the server device 404. At the phone application, the user may elect to transfer the call request to the client device 402. Accordingly, the cellular hardware interface 414 may receive an instruction from the phone application and transmit the request 444 to the cellular interface translator 412. The cellular interface translator communicates a request 446 via the cellular data channel generated over the datalink layer communication channel 418 to the cellular interface translator 410 of the client device 402. The cellular interface translator 410 transmits a request 448 to the application 408 (e.g., the phone application) on the client device 404. If a user accepts the call, then a voice data channel 452 is established between the recipient and the application 408. The voice data is transmitted between the cellular network 406, the various components of the client device 402, and the server device 404 across the cellular data channel generated over the datalink layer communication channel 418.

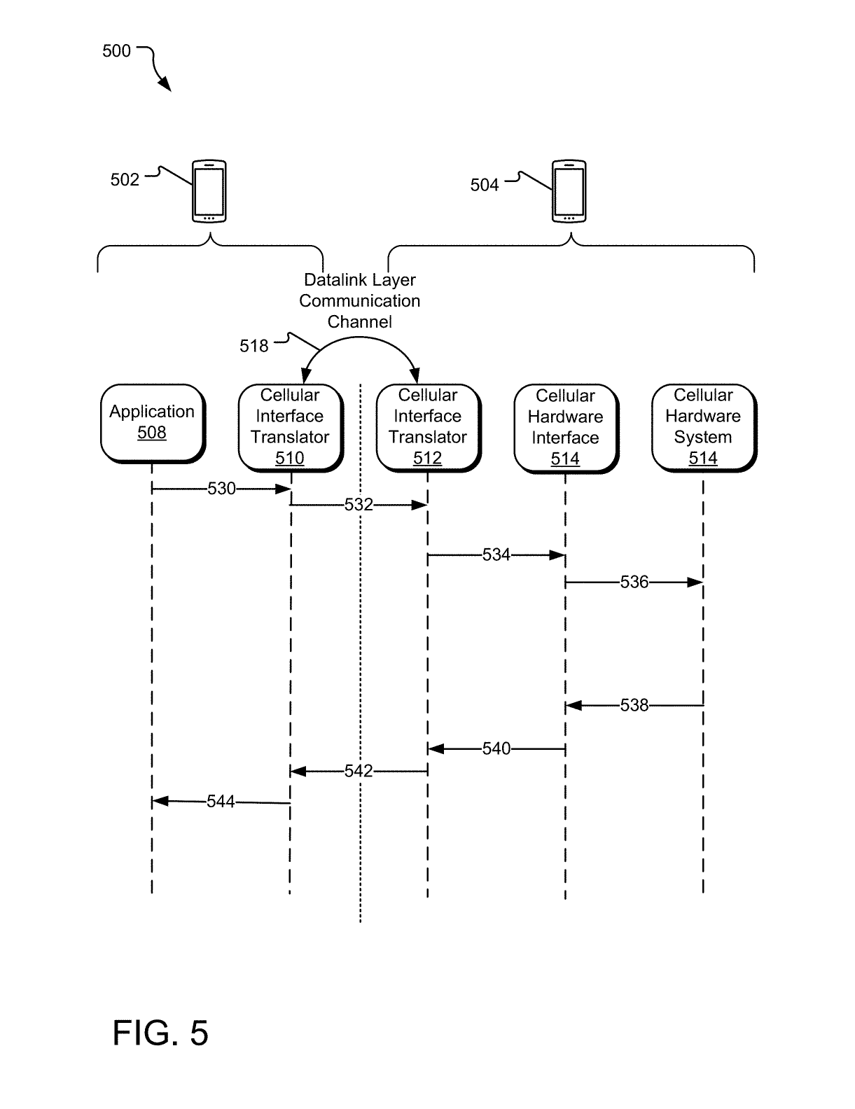

FIG. 5 illustrates a diagram 500 of example data sources and flows for cellular extension on a datalink layer communication channel. The diagram 500 includes a client device 502 and a server device 504. The client device 502 includes an application 508 and a cellular interface translator 512. The server device 504 includes a cellular interface translator 512, a cellular hardware interface 514 and a cellular hardware system 516. The client device 502 and the server device 504 have generated a cellular data channel over an established datalink layer communication channel 518. The datalink layer communication channel 518 may be established by a pairing process, such as BlueTooth pairing or Wi-Fi connection, for example. The cellular data channel is established by connecting the cellular interface translator 510 of the client device 502 and the cellular interface translator 512 of the server device 504.

FIG. 5 specifically illustrates cellular data extension on a datalink layer communication channel for retrieving local resource information from the server device 504 and by the client device 502. The application 508 of the client device 502 may request the local resource for authentication to access data of the application 508. The application 508 transmits a request 530 to the cellular interface translator 510. The cellular interface translator 510 transmits a request 532 over the cellular data channel generated over the datalink layer communication channel 518. The cellular interface translator 512 of the server device 504 receives the request 532 and transmits a request 534 to the cellular hardware interface 514. The cellular hardware interface 514 transmits a resource request 536 to the cellular hardware system 516. The cellular hardware system 516 responds to the request with resource data (e.g., subscriber identifying information or device identifying information) retrieved from a SIM card (not shown), for example. The data is sent as a response 538 to the cellular hardware interface 514, which transmits the data as a response 540 to the cellular interface translator 512. The cellular interface translator 512 transmits the data over the cellular data channel generated over the datalink layer communication channel 518 as a response 542. The cellular interface translator 510 sends the data to the application 508 as a response 544. The application 508 may then utilize the data for authentication of the device 502 for access to data or other resources associated with the application.

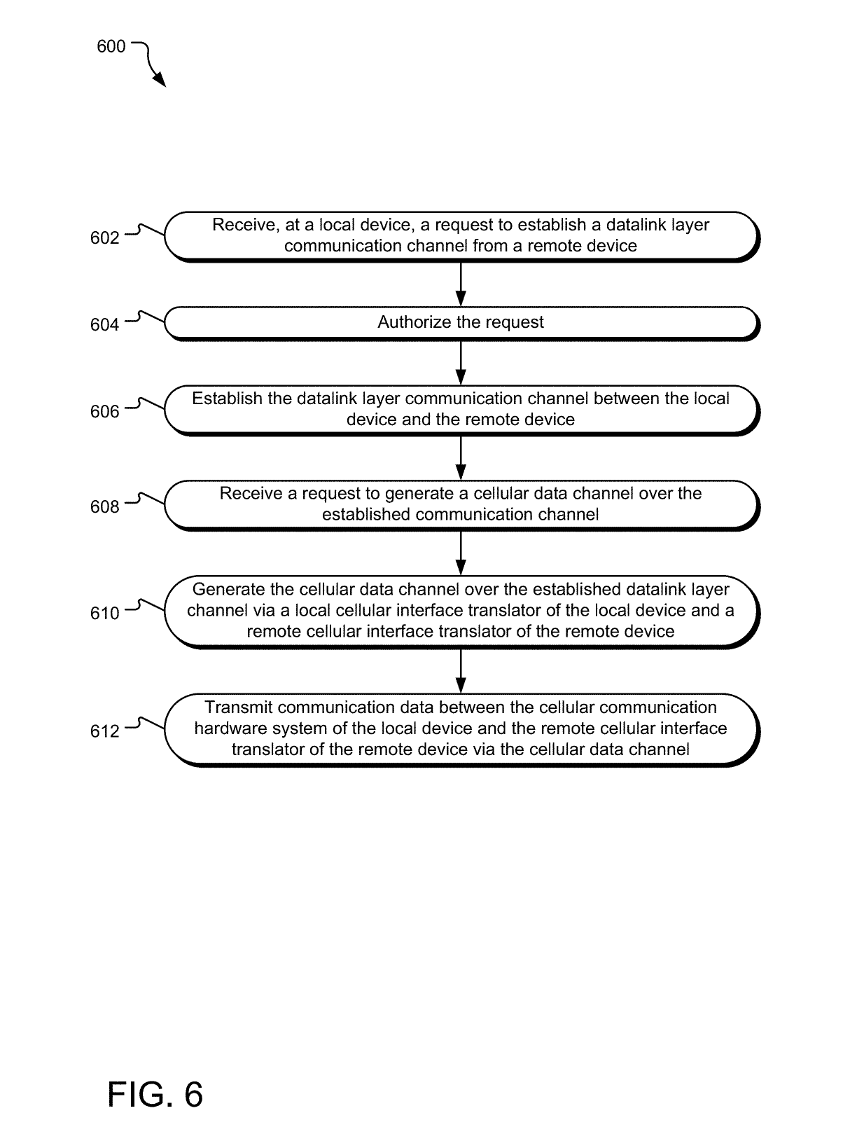

FIG. 6 illustrates example operations 600 for cellular extension on a datalink layer communication channel. A receiving operation 602 receives, at a local device, a request to establish a datalink layer communication channel from a remote device. An authorizing operation 604 authorizes the request. Responsive to authorizing the request, an establishing operation 606 establishes the datalink layer communication channel between the local device and the remote device. It should be understood that the local device may transmit a request to the remote device, the remote device may authorize the request, and then the datalink layer communication channel is established in the establishing operation 606. The establishing operation 606 may include performing a handshake process including trading keys, credentials, etc.

A receiving operation 608 may receive a request, from the remote device, to generate a cellular data channel over the established communication channel. In some implementations, the local device transmits the request to generate a cellular data channel to the remote device. A generating operation 610 generates the cellular data channel over the established data link layer channel via local cellular interface translator and a remote cellular interface translator of the remote device. A transmitting operation 612 transmits communication data between the cellular communication hardware system of the local device and the remote cellular interface translator of the remote device via the generated cellular data channel. The transmitting operation 612 may include receiving and transmitting cellular voice calls, transmitting cellular voice data, transmitting and receiving SMS messages, and receiving requests for and transmitting local resource data to the remote device.

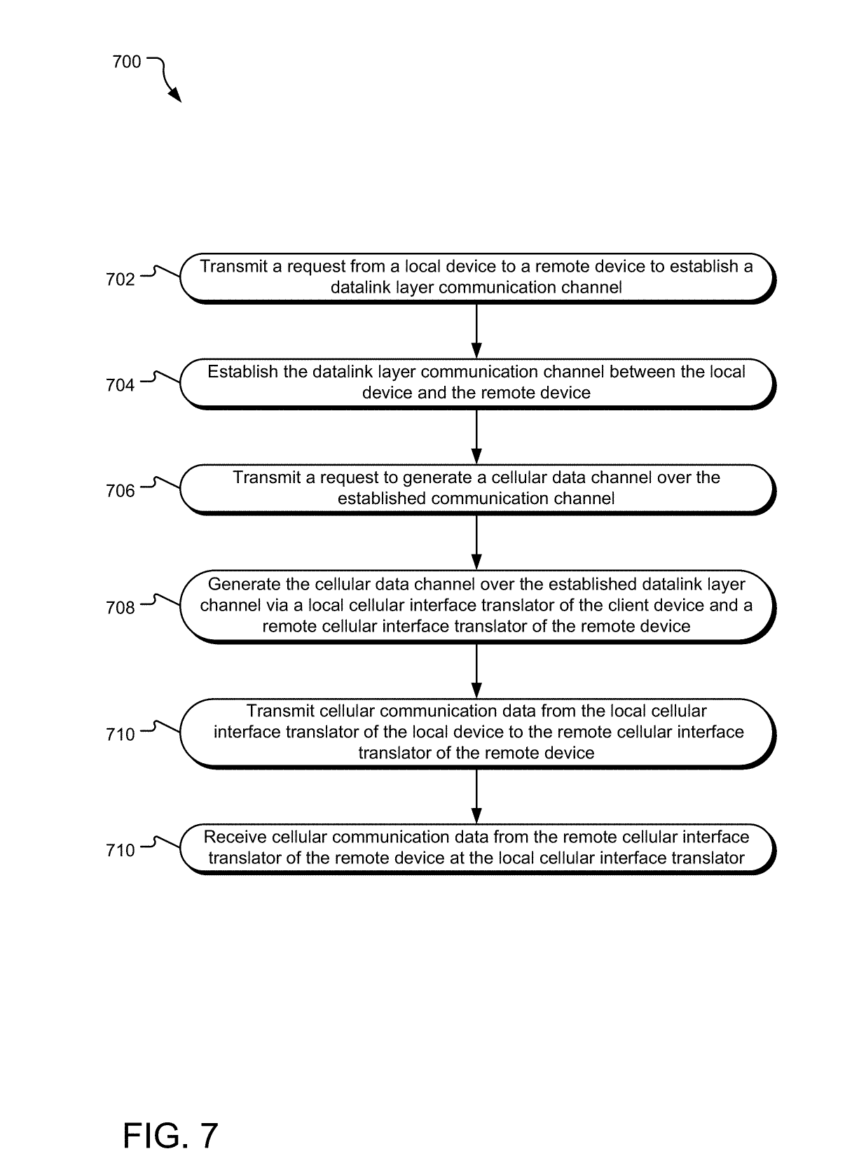

FIG. 7 illustrates example operations 700 for cellular extension on a datalink layer communication channel. A transmitting operation 702 transmits, from a local device to a remote device, a request to establish a datalink layer communication channel. An establishing operation 704 establishes the datalink layer communication channel between the local device and the remote device. It should be understood that the local device may transmit a request to the remote device, the remote device may authorize the request, and then the datalink layer communication channel is established in the establishing operation 704. The establishing operation 704 may include performing a handshake process including trading keys, credentials, etc.

A transmitting operation 706 transmits a request to generate a cellular data channel over the established communication channel. In some implementations, the remote device transmits the request to generate a cellular data channel to the local device. A generating operation 708 generates the cellular data channel over the established data link layer channel via local cellular interface translator and a remote cellular interface translator of the remote device. A transmitting operation 712 transmits cellular communication data from the local cellular interface translator of the local device to the remote cellular interface translator of the remote device. The transmitting operation 712 may include transmitting cellular voice calls, transmitting cellular voice data, transmitting SMS messages, and transmitting requests for local resource data to the remote device. A receiving operation 710 receives cellular communication data from the remote cellular translator of the remote device at the local cellular interface translator of the local device. The received data may include cellular voice data, received SMS messages, and resource data retrieved from the cellular hardware system of the remote device.

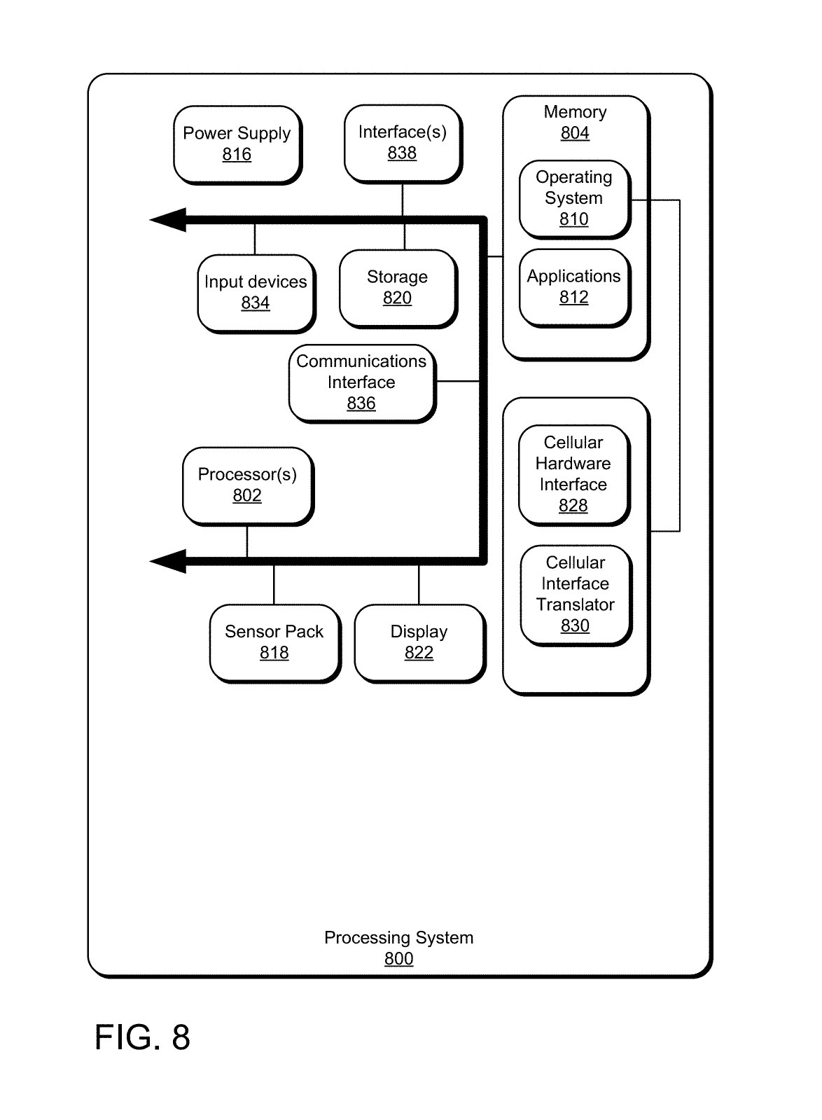

FIG. 8 illustrates an example system (labeled as a processing system 800) that may be useful in implementing the described technology. The processing system may be a client device such as a laptop, mobile device, desktop, tablet, or a server/cloud device. The processing system 800 includes one or more processor(s) 802, and a memory 804. The memory 804 generally includes both volatile memory (e.g., RAM) and non-volatile memory (e.g., flash memory). An operating system 810 resides in the memory 804 and is executed by the processor(s) 802. The operating system 810 may include a cellular hardware interface 828 (e.g., a radio interface layer (RIL)) and a cellular interface translator 830 stored in the memory 804 and executed by the processor(s) 802 for extending a datalink layer for cellular communication.

One or more application programs 812 modules or segments, such as a phone or SMS application are loaded in the memory 804 and/or the storage 820 and executed by the processor(s) 802. Data such as paired device data, identifying data, resource data, etc. may be stored in the memory 804, or the storage 820 and may be retrievable by the processor(s) 802 for use extending a datalink layer for cellular communication and for use by the cellular hardware interface 828, the cellular interface translator 830 and/or other applications 812. The storage 820 may be local to the processing system 800 or may be remote and communicatively connected to the processing system 800 and may include another server.

The processing system 800 includes a power supply 816, which is powered by one or more batteries or other power sources and which provides power to other components of the processing system 800. The power supply 816 may also be connected to an external power source that overrides or recharges the built-in batteries or other power sources.

The processing system 800 may include one or more communications interface 836 to provide network and device connectivity (e.g., mobile phone network, Wi-Fi®, Bluetooth®, etc.) to one or more other servers and/or client devices/entities (e.g., mobile devices, desktop computers, or laptop computers, USB devices). The processing system 800 may use the communications interface 836 and any other types of communication devices for establishing connections over a wide-area network (WAN) or local-area network (LAN). It should be appreciated that the network connections shown are exemplary and that other communications devices and means for establishing a communications link between the processing system 800 and other devices may be used.

The processing system 800 may include one or more input devices 834 such that a user may enter commands and information (e.g., a keyboard or mouse). These and other input devices may be coupled to the server by one or more interfaces 838 such as a serial port interface, parallel port, universal serial bus (USB), a datalink layer interface (e.g., BlueTooth, Wi-Fi, NFC), etc. The processing system 800 may further include a display 822 such as a touch screen display. The processing system 800 may further include a sensor pack 818, which includes one or more sensors that detect locating data such as identifying data, environment data, sound data, image/video data, signal data, etc.

The processing system 800 may include a variety of tangible processor-readable storage media and intangible processor-readable communication signals. Tangible processor-readable storage can be embodied by any available media that can be accessed by the processing system 800 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing system 800. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means an intangible communications signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

An example system for extending a datalink layer from a local device to a remote device includes a datalink layer interface configured to establish a datalink layer communication channel between the local device and the remote device and to communicate between the local device and the remote device via the established datalink layer communication channel to process a request for generating a cellular data channel over the established datalink layer communication channel. The datalink layer communication channel is established responsive to a request initiated at one of the local device and the remote device. The system further includes a local cellular interface translator configured to generate the cellular data channel over the established datalink layer communication channel and to transmit communication data between cellular communication hardware system of the local device and a remote cellular interface translator of the remote device via the cellular data channel generated over the datalink layer communication channel. The remote device does not utilize a remote subscriber identity module (SIM) to communicate the communication data.

Another example system of any preceding system further includes the local cellular interface translator being further configured to receive a call request from the remote cellular interface translator via the cellular data channel and to communicate voice data between the cellular communication hardware system of the local device and the remote cellular interface translator of the remote device via the cellular data channel generated over the datalink layer communication channel. The cellular communication hardware system of the local device communicates the voice data with a cellular network external to the local device.

Another example system of any preceding system includes the local cellular interface translator being further configured to receive an incoming call request at the cellular communication hardware system of the local device and to communicate the incoming call request to the remote cellular interface translator of the remote device via the cellular data channel generated over the datalink layer communication channel.

Another example system of any preceding system includes the local cellular interface translator being further configured to communicate voice data between the cellular communication hardware system of the local device and the remote cellular interface translator of the remote device via the cellular data channel generated over the datalink layer communication channel. The cellular communication hardware system of the local device communicates the voice data with a cellular network external to the local device.

Another example system of any preceding system further includes the local cellular interface translator being further configured to receive a request for local resource data from the remote cellular interface translator at the local cellular interface translator via the cellular data channel and to communicate the local resource data to the remote cellular interface translator via the cellular data channel the local resource data retrieved from the cellular communication hardware system of the local device and usable by an application executable on the remote device.

Another example system of any preceding system further includes the application executable on the remote device utilizing the local resource data retrieved from the cellular communication hardware system of the local device to authenticate access to application data of the application.

Another example system of any preceding system further includes the datalink layer communication channel being established via a BlueTooth communication protocol.

Another example system of any preceding system further includes the datalink layer communication channel being established via Wi-Fi.

An example method for extending a datalink layer from a local device to a remote device includes establishing a datalink layer communication channel between the local device and the remote device. The datalink layer communication channel is established responsive to a request initiated at one of the local device and the remote device. The method further includes communicating between the local device and the remote device via the established datalink layer communication channel to process a request for generating a cellular data channel over the established datalink layer communication channel and generating the cellular data channel over the established datalink layer communication channel via a local cellular interface translator of the local device and a remote cellular interface translator of the remote device. The local cellular interface translator is configured to communicate with a cellular communication hardware system of the local device via a cellular interface of the local device. The method further includes transmitting communication data between the cellular communication hardware system of the local device and the remote cellular interface translator of the remote device via the cellular data channel generated over the datalink layer communication. The remote device does not utilize a remote subscriber identity module (SIM) to communicate the communication data.

Another example method of any preceding method includes transmitting the communication data between the cellular communication hardware system of the local device and the remote cellular interface translator of the remote device by receiving a call request from the remote cellular interface translator of the remote device at the local cellular interface translator of the local device via the cellular data channel and communicating voice data between the cellular communication hardware system of the local device and the remote cellular interface translator of the remote device via the cellular data channel generated over the datalink layer communication channel. The call request identifies a call recipient, and the cellular communication hardware system of the local device communicates the voice data with a cellular network external to the local device.

Another example method of any preceding method further includes wherein transmitting the communication data between the cellular communication hardware system of the local device and the remote cellular interface translator of the remote device by receiving an incoming call request at the cellular communication hardware system of the local device and communicating the incoming call request to the remote cellular interface translator of the remote device via the cellular data channel generated over the datalink layer communication channel.

Another example method of any preceding method further includes communicating voice data between the cellular communication hardware system of the local device and the remote cellular interface translator of the remote device via the cellular data channel generated over the datalink layer communication channel. The cellular communication hardware system of the local device communicates the voice data with a cellular network external to the local device.

Another example method of any preceding method further includes transmitting the communication data between the cellular communication hardware system of the local device and the remote cellular interface translator of the remote device by receiving a request for local resource data from the remote cellular interface translator at the local cellular interface translator via the cellular data channel and communicating the local resource data to the remote cellular interface translator via the cellular data channel, the local resource data retrieved from the cellular communication hardware system of the local device and usable by an application executable on the remote device.

Another example method of any preceding method further includes wherein the application executable on the remote device utilizing the local resource data retrieved from the cellular communication hardware system of the local device to authenticate access to data associated with the application.

Another example method of any preceding method further includes the datalink layer communication channel being established via a BlueTooth communication protocol.

Another example method of any preceding method further includes the datalink layer communication channel being established via Wi-Fi.

One or more example tangible processor-readable storage transmitting communication data between the cellular communication hardware system of the local device and the remote cellular interface translator of the remote device via the cellular data channel generated over the datalink layer communication channel establishing a datalink layer communication channel between the local device and the remote device. The datalink layer communication channel is established responsive to a request initiated at one of the local device and the remote device. The process further includes communicating between the local device and the remote device via the established datalink layer communication channel to process a request for generating a cellular data channel over the established datalink layer communication channel and generating the cellular data channel over the established datalink layer communication channel via a local cellular interface translator of the local device and a remote cellular interface translator of the remote device. The local cellular interface translator is configured to communicate with a cellular communication hardware system of the local device via a cellular interface of the local device. The process further includes transmitting communication data between the cellular communication hardware system of the local device and the remote cellular interface translator of the remote device via the cellular data channel generated over the datalink layer communication channel. The remote device does not utilize a remote subscriber identity module (SIM) to communicate the communication data.

Another example tangible processor-readable storage media of any preceding processor-readable storage media embodied with instructions for executing on one or more processors a process including transmitting the communication data between the cellular communication hardware system of the local device and the remote cellular interface translator of the remote device by receiving a call request from the remote cellular interface translator at the local cellular interface translator via the cellular data channel, the call request identifying a call recipient and communicating voice data between the cellular communication hardware system of the local device and the remote cellular interface translator of the remote device via the cellular data channel generated over the datalink layer communication channel. The cellular communication hardware system of the local device communicating the voice data with a cellular network external to the local device.

Another example tangible processor-readable storage media of any preceding processor-readable storage media embodied with instructions for executing on one or more processors a process including transmitting the communication data between the cellular communication hardware system of the local device and the remote cellular interface translator of the remote device by receiving an incoming call request at the cellular communication hardware system of the local device and communicating the incoming call request to the remote cellular interface translator of the remote device via the cellular data channel generated over the datalink layer communication channel.

Another example tangible processor-readable storage media of any preceding processor-readable storage media embodied with instructions for executing on one or more processors a process including transmitting the communication data between the cellular communication hardware system of the local device and the remote cellular interface translator of the remote device by receiving a request for local resource data from the remote cellular interface translator at the local cellular interface translator via the cellular data channel and communicating the local resource data to the remote cellular interface translator via the cellular data channel. The local resource data is retrieved from the cellular communication hardware system of the local device and usable by an application executable on the remote device.

An example system for extending a datalink layer from a local device to a remote device includes means for establishing a datalink layer communication channel between the local device and the remote device. The datalink layer communication channel is established responsive to a request initiated at one of the local device and the remote device. The system further includes means for communicating between the local device and the remote device via the established datalink layer communication channel to process a request for generating a cellular data channel over the established datalink layer communication channel and generating the cellular data channel over the established datalink layer communication channel via a local cellular interface translator of the local device and a remote cellular interface translator of the remote device. The local cellular interface translator supports communication with a cellular communication hardware system of the local device via a cellular interface of the local device. The system further includes means for transmitting communication data between the cellular communication hardware system of the local device and the remote cellular interface translator of the remote device via the cellular data channel generated over the datalink layer communication channel. The remote device does not utilize a remote subscriber identity module (SIM) to communicate the communication data.

Another example system of any preceding system includes means for transmitting the communication data between the cellular communication hardware system of the local device and the remote cellular interface translator of the remote device by receiving a call request from the remote cellular interface translator of the remote device at the local cellular interface translator of the local device via the cellular data channel and communicating voice data between the cellular communication hardware system of the local device and the remote cellular interface translator of the remote device via the cellular data channel generated over the datalink layer communication channel. The system supports the call request identifying a call recipient and the cellular communication hardware system of the local device communicating the voice data with a cellular network external to the local device.

Another example system of any preceding system includes means for transmitting the communication data between the cellular communication hardware system of the local device and the remote cellular interface translator of the remote device by receiving an incoming call request at the cellular communication hardware system of the local device and communicating the incoming call request to the remote cellular interface translator of the remote device via the cellular data channel generated over the datalink layer communication channel.

Another example system of any preceding system includes means for communicating voice data between the cellular communication hardware system of the local device and the remote cellular interface translator of the remote device via the cellular data channel generated over the datalink layer communication channel. The cellular communication hardware system of the local device supports communicating the voice data with a cellular network external to the local device.

Another example system of any preceding system includes means for transmitting the communication data between the cellular communication hardware system of the local device and the remote cellular interface translator of the remote device by receiving a request for local resource data from the remote cellular interface translator at the local cellular interface translator via the cellular data channel and communicating the local resource data to the remote cellular interface translator via the cellular data channel. The local resource data is retrieved from the cellular communication hardware system of the local device and usable by an application executable on the remote device.

Another example system for any preceding system includes means for the application executable on the remote device utilizing the local resource data retrieved from the cellular communication hardware system of the local device to authenticate access to data associated with the application.

Another example system of any preceding system includes means for the datalink layer communication channel being established via a BlueTooth communication protocol.

Another example system of any preceding system includes means for the datalink layer communication channel being established via Wi-Fi.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A system for extending a datalink layer from a local device to a remote device comprising:
a datalink layer interface configured to establish a datalink layer communication channel between the local device and the remote device and to communicate between the local device and the remote device via the established datalink layer communication channel to process a request for generating a cellular data channel over the established datalink layer communication channel, the datalink layer communication channel established responsive to a request initiated at one of the local device and the remote device; and
a local cellular interface translator configured to generate the cellular data channel over the established datalink layer communication channel and to transmit communication data between a cellular communication hardware system of the local device and a remote cellular interface translator of the remote device via the cellular data channel generated over the datalink layer communication channel, the remote device not utilizing a remote subscriber identity module (SIM) to communicate the communication data.

2. The system of claim 1 wherein the local cellular interface translator is further configured to receive a call request from the remote cellular interface translator via the cellular data channel and to communicate voice data between the cellular communication hardware system of the local device and the remote cellular interface translator of the remote device via the cellular data channel generated over the datalink layer communication channel, the cellular communication hardware system of the local device communicating the voice data with a cellular network external to the local device.

3. The system of claim 1 wherein the local cellular interface translator is further configured to receive an incoming call request at the cellular communication hardware system of the local device and to communicate the incoming call request to the remote cellular interface translator of the remote device via the cellular data channel generated over the datalink layer communication channel.

4. The system of claim 3 wherein the local cellular interface translator is further configured to communicate voice data between the cellular communication hardware system of the local device and the remote cellular interface translator of the remote device via the cellular data channel generated over the datalink layer communication channel, the cellular communication hardware system of the local device communicating the voice data with a cellular network external to the local device.

5. The system of claim 1 wherein the local cellular interface translator is further configured to receive a request for local resource data from the remote cellular interface translator at the local cellular interface translator via the cellular data channel and to communicate the local resource data to the remote cellular interface translator via the cellular data channel the local resource data retrieved from the cellular communication hardware system of the local device and usable by an application executable on the remote device.

6. The system of claim 5 wherein the application executable on the remote device utilizes the local resource data retrieved from the cellular communication hardware system of the local device to authenticate access to application data of the application.

7. The system of claim 1 wherein the datalink layer communication channel is established via a BlueTooth communication protocol.

8. The system of claim 1 wherein the datalink layer communication channel is established via Wi-Fi.

9. A method for extending a datalink layer from a local device to a remote device comprising:
establishing a datalink layer communication channel between the local device and the remote device, the datalink layer communication channel established responsive to a request initiated at one of the local device and the remote device;
communicating between the local device and the remote device via the established datalink layer communication channel to process a request for generating a cellular data channel over the established datalink layer communication channel;
generating the cellular data channel over the established datalink layer communication channel via a local cellular interface translator of the local device and a remote cellular interface translator of the remote device, the local cellular interface translator configured to communicate with a cellular communication hardware system of the local device via a cellular interface of the local device; and
transmitting communication data between the cellular communication hardware system of the local device and the remote cellular interface translator of the remote device via the cellular data channel generated over the datalink layer communication channel, the remote device not utilizing a remote subscriber identity module (SIM) to communicate the communication data.

10. The method of claim 9 wherein transmitting the communication data between the cellular communication hardware system of the local device and the remote cellular interface translator of the remote device further comprises:
receiving a call request from the remote cellular interface translator of the remote device at the local cellular interface translator of the local device via the cellular data channel, the call request identifying a call recipient; and
communicating voice data between the cellular communication hardware system of the local device and the remote cellular interface translator of the remote device via the cellular data channel generated over the datalink layer communication channel, the cellular communication hardware system of the local device communicating the voice data with a cellular network external to the local device.

11. The method of claim 9 wherein transmitting the communication data between the cellular communication hardware system of the local device and the remote cellular interface translator of the remote device further comprises:
receiving an incoming call request at the cellular communication hardware system of the local device; and
communicating the incoming call request to the remote cellular interface translator of the remote device via the cellular data channel generated over the datalink layer communication channel.

12. The method of claim 11 further comprising:
communicating voice data between the cellular communication hardware system of the local device and the remote cellular interface translator of the remote device via the cellular data channel generated over the datalink layer communication channel, the cellular communication hardware system of the local device communicating the voice data with a cellular network external to the local device.

13. The method of claim 9 wherein transmitting the communication data between the cellular communication hardware system of the local device and the remote cellular interface translator of the remote device further comprises:
receiving a request for local resource data from the remote cellular interface translator at the local cellular interface translator via the cellular data channel; and
communicating the local resource data to the remote cellular interface translator via the cellular data channel, the local resource data retrieved from the cellular communication hardware system of the local device and usable by an application executable on the remote device.

14. The method of claim 13 wherein the application executable on the remote device utilizes the local resource data retrieved from the cellular communication hardware system of the local device to authenticate access to data associated with the application.

15. The method of claim 9 wherein the datalink layer communication channel is established via a BlueTooth communication protocol.

16. The method of claim 9 wherein the datalink layer communication channel is established via Wi-Fi.

17. One or more tangible processor-readable storage media embodied with instructions for executing on one or more processors and circuits of a device a process for extending a datalink layer from a local device to a remote device comprising:
establishing a datalink layer communication channel between the local device and the remote device, the datalink layer communication channel established responsive to a request initiated at one of the local device and the remote device;
communicating between the local device and the remote device via the established datalink layer communication channel to process a request for generating a cellular data channel over the established datalink layer communication channel;
generating the cellular data channel over the established datalink layer communication channel via a local cellular interface translator of the local device and a remote cellular interface translator of the remote device, the local cellular interface translator configured to communicate with a cellular communication hardware system of the local device via a cellular interface of the local device; and
transmitting communication data between the cellular communication hardware system of the local device and the remote cellular interface translator of the remote device via the cellular data channel generated over the datalink layer communication channel, the remote device not utilizing a remote subscriber identity module (SIM) to communicate the communication data.

18. The one or more tangible processor-readable storage media of claim 17 wherein transmitting the communication data between the cellular communication hardware system of the local device and the remote cellular interface translator of the remote device further comprises:
receiving a call request from the remote cellular interface translator at the local cellular interface translator via the cellular data channel, the call request identifying a call recipient; and
communicating voice data between the cellular communication hardware system of the local device and the remote cellular interface translator of the remote device via the cellular data channel generated over the datalink layer communication channel, the cellular communication hardware system of the local device communicating the voice data with a cellular network external to the local device.

19. The one or more tangible processor-readable storage media of claim 17 wherein transmitting the communication data between the cellular communication hardware system of the local device and the remote cellular interface translator of the remote device further comprises:
receiving an incoming call request at the cellular communication hardware system of the local device; and
communicating the incoming call request to the remote cellular interface translator of the remote device via the cellular data channel generated over the datalink layer communication channel.

20. The one or more tangible processor-readable storage media of claim 17 wherein transmitting the communication data between the cellular communication hardware system of the local device and the remote cellular interface translator of the remote device further comprises:
receiving a request for local resource data from the remote cellular interface translator at the local cellular interface translator via the cellular data channel; and
communicating the local resource data to the remote cellular interface translator via the cellular data channel, the local resource data retrieved from the cellular communication hardware system of the local device and usable by an application executable on the remote device.
